(19) United States
(12) Patent Application Publication
(10) Pub. No.: US 2002/0166468 A1
(43) Pub. Date: Nov. 14, 2002

(54) Patterning mask and method

(75) Inventors: Heinz Schmid, Waedenswil (CH); David Juncker, Zurich (CH); Bruno Michel, Adliswil (CH); Heiko Wolf, Pfaeffikon (CH); Matthias Geissler, Thalwil (CH)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/104,840

(22) Filed: Mar. 22, 2002

(30) Foreign Application Priority Data
Mar. 22, 2001 (EP) 01810293.9

(51) Int. Cl. B41L 13/00

(52) U.S. Cl. 101/127

(57) ABSTRACT

The invention relates to a patterning mask comprising a substantially planar patterned printing layer. The printing layer comprises a substantially inelastic stencil layer and a substantially elastic seal layer that is fixed at the stencil layer. The seal layer when being in contact with a substrate serves as a seal for a liquid or viscous or gaseous material that is fillable through the patterned printing layer onto the substrate. Additionally the mask may comprise a mesh layer. The mesh layer has a two-dimensional regular pattern of openings separated by solid elements such as wires and can provide a rigidity in its mesh plane.

The invention relates to a patterning mask and, more particularly, to a mask for use in printing an ink or bringing another material onto a substrate. Furthermore, the invention relates to a patterning method using such a mask.

### TECHNICAL FIELD AND BACKGROUND OF THE INVENTION

U.S. Pat. No. 5,359,928 which issued Nov. 1, 1994 discloses a method for preparing and using a screen printing stencil having raised edges. The raised edges act as a gasket between the stencil and the substrate during printing and are supposed to prevent bleeding or bridging of print material to enable precise deposition of the printing material on the substrate and formation of high resolution images. Moreover, the raised edges provide a base for smooth release of the printing material. The orifice walls are smooth and tapered, being wider on the substrate side which allows an unobstructed release of printed material. The protruding edges are made from the same material as the whole mask. The sealing provided between the raised edges and the substrate is not sufficient to prevent leaking of thin i.e. low-viscous materials. Furthermore the sealing is only effective when the raised edges are pressed against the surface of the substrate, which renders a use over large areas complicated.

WO 99/54786 which issued Oct. 28, 1999 describes a pure elastomeric mask and its use in fabrication of devices. The elastomeric mask seals against substrate surfaces, allowing deposition from fluid phase, gas phase, and the like or removal of material using gaseous or liquid etchants. The mask then can be peeled from the surface of the substrate leaving the patterned material behind. Multi-layered mask techniques are described in which openings in an upper mask allow selected openings of a lower mask to remain unshielded, while other openings of the lower mask are shielded. The described mask is elastic in any direction and hence particularly prone to mechanical influences which might lead to pattern distortion, e.g. when using a squeegee. The mask furthermore does not allow one to create arbitrary patterns on a substrate because it does not hold freestanding structures.

U.S. Pat. No. 4,078,488 which issued Mar. 14, 1978 describes a screen for use in a silk screen printing process which is made by a process comprising the steps of forming a positive image of a desired print, applying it to a screen so as to obstruct apertures therein corresponding to the positive image, filling all unobstructed apertures in the screen with a flexible polymeric material and then removing the positive image. The resulting screen comprises a mesh combined with a silicone rubber mask whereby the silicone mask is thick enough to surround and bury the mesh in itself. The screen exhibits an elasticity which prevents it from breaking when being bent. This device is supposed to allow a screen printing method wherein the device is pressed locally to a flat surface of e.g. a paper without breaking the device itself.

In U.S. Pat. No. 6,095,041 which issued Aug. 1, 2000, the positioning of mesh side features in a stencil mask is controlled to produce a mask which possesses high structural integrity and which exhibits a low service life. Mesh side feature control is introduced to eliminate certain unnecessary design side channels and mesh side via openings. Mesh side feature placement at T-shaped design side junctions is also controlled to produce a more uniform distribution of material which is screened through the stencil mask.

### SUMMARY OF THE INVENTION

In accordance with the present invention, a patterning mask is described comprising a substantially planar patterned printing layer. The printing layer comprises a substantially inelastic stencil layer and a substantially elastic seal layer that is fixed at the stencil layer. The seal layer when being in contact with a substrate serves as a seal for a liquid or viscous or gaseous material that is fillable through the patterned printing layer onto the substrate. In the following, the liquid or viscous or gaseous material is referred to as ink, but it can be any other liquid, viscous, or gaseous material such as an etchant. Additionally, the mask may comprise a mesh layer. The mesh layer has a two-dimensional regular pattern of openings separated by solid elements and can provide a rigidity in its mesh plane.

The invention further provides a patterning device comprising a stencil layer attached to a patterned, soft sealing layer. A mechanically stable screen layer can be added.

According to a first aspect of the invention, a patterning mask is provided that allows intimate contact between the mask and the substrate, reducing the risk of pattern blurring or distortion. The elastic material serves as a seal for the ink and thereby reduces pattern blurring i.e. distortion caused by leakage of the ink between mask and substrate. Thereby, thinner and less viscous inks can be used and smaller features can be printed with smaller pattern scales. The elastic seal layer opens up the field of stencil-based printing to a multitude of new inks which hitherto have not been usable because of the problem of pattern blurring and distortion due to ink flow on the substrate.

The patterning mask incorporates a rigid layer on top of the elastic material witch assures a high accuracy and stability of the patterning mask. Thereby accurate prints can be made, the handling of the mask during the steps of positioning, cleaning and inspection is facilitated and a squeegee can be used if desired to apply the ink without risking pattern distortion. The patterning mask furthermore allows one to create arbitrary patterns on a substrate because the stencil layer holds also freestanding structures of the elastic sealing layer.

The patterning mask further provides for a friction, respectively, or an adhesion force towards corresponding substrates, which contributes to holding the position of the mask on the substrate, thereby reducing the necessity of an alignment control, e.g. via a permanent mask frame to hold the patterning mask on the substrate. The patterning mask can therefore be applied even on curved substrates. The patterning mask in contact with the substrate can be handled as one single entity which enables complex or multiple processing steps.

The patterning mask can also be placed on a second patterning mask to block or guide the ink towards the substrate. Complex patterns can be obtained in this way with only a small set of patterning masks. Multiple inks can be applied in subsequent processing steps.

The seal layer of the patterning mask can have arbitrary and smaller structures than the stencil layer. The seal layer can have small channels which are masked by the stencil layer, wherein the ink is transported sideways to the substrate. The seal layer can preferentially cover the rim of the stencil layer.

The patterning mask with a mesh layer furthermore allows the creation of arbitrary patterns on the substrate because the mesh layer may hold freestanding structures in the printing layer.

The printing layer comprises a stencil layer which is substantially inelastic and a seal layer which is substantially elastic. Thereby the stencil layer can add to the mechanical stability of the patterning mask while the seal layer can exert its functionality as an elastic seal. Since the elastic seal layer is supported mechanically by the stencil layer, the mesh layer need not provide this mechanical support. This means that the printing layer can extend into spaces where the mesh layer has an opening, whereby the printing layer through its own mechanical stability provides the full functionality with regard to accurate patterning capability. Whereas without the stencil layer the elastic seal layer would be prone to instability and bending which leads to a risk of pattern distortion, this is not the case with the present invention. With the patterning mask of the present invention, patterns can be created that have smaller dimensions than the mesh layer openings.

Furthermore the combination of a nonelastic stencil layer with an elastic seal layer allows the two layers to be relatively thin. The thickness of the printing layer is of relevance as this thickness is in some form correlated to the minimum orifice dimension feasible. For patterning the printing layer, a lithographic, i.e. optical patterning process can be used. The ratio of the printing layer thickness to the orifice dimension is determined by the fact that the light and/or the etchant must be able to reach or penetrate through the whole printing layer in order to manufacture the orifice. The stencil layer is at the same time a support structure that keeps the seal layer separated from the mesh layer, i.e. the seal layer does not extend through the openings of the mesh layer. This has two advantages. First, less elastic material is needed for the seal layer. Second, the seal layer is automatically thinner because it is reduced by the thickness of the mesh layer. A thinner seal layer is more precise in its elasticity and less prone to pattern distortion due to a lateral deformation of the seal layer. The stencil layer provides for the seal layer a flat backplane in contrast to the mesh layer which due to its inhomogeneous structure provides a rather uneven backplane. For achieving proper sealing, the stencil layer provides a more even pressure distribution again contributing to the resulting pattern precision.

When the printing layer extends into the openings of the mesh layer a mechanical fixation between the printing layer and the mesh layer is achieved. The mesh layer may even be partially buried in the printing layer.

The substantially elastic material may comprise an optically curable elastomer. This has the advantage that a well-known process can be used to manufacture the elastic material. Any prepolymer or monomer or mixtures thereof that reacts upon an irradiation with UV/visible light to form an elastomer network can be used. A preferred example is a light-curable siloxane, acrylate or methacrylate, e.g. LF55GN.

The mesh layer may comprise a web of wires which is a commercially available mesh and is hence cheaper than a specially manufactured mesh. The mesh layer need not have its openings in the same small dimensions as may be the orifices in the printing layer.

When the stencil layer comprises a photoresist material, it can be patterned using a standard photolithographic method which is well known and relatively cheap.

When the seal layer and the stencil layer comprise a substantially similar pattern the same patterning steps can be used to pattern them.

### BRIEF DESCRIPTION OF THE DRAWING

These and other features, objects, and advantages of the present invention will become apparent upon consideration of the following detailed description of the invention when read in conjunction with the drawing in which:

FIG. 1A is a cross-section view of a patterning mask with a mesh, stencil- and seal layer,

FIG. 1B is a top view of the mask of FIG. 1A,

FIG. 2 is a cross-section view of the patterning mask on a substrate in a printing step,

FIG. 3 is a cross section view of a second embodiment of the patterning mask with the stencil and seal layer reaching into areas of the mesh openings of the mesh layer,

FIG. 4 is a microscopic photograph of a patterning mask according to FIG. 3,

FIG. 5 is a cross section of a patterning mask with a seal layer with tilted walls,

FIG. 6A is cross-section view along the line 6A-6A of FIG. 6B showing a patterning mask with a seal layer that has a different pattern than the stencil layer.

FIG. 6B is a top view of patterning mask 26.

FIG. 6C is a view of the pattern printed by patterning mask 26.

All the figures are for sake of clarity not shown in real dimensions, nor are the relations between the dimensions shown in a realistic scale.

### DESCRIPTION OF THE PREFERRED EMBODIMENTS

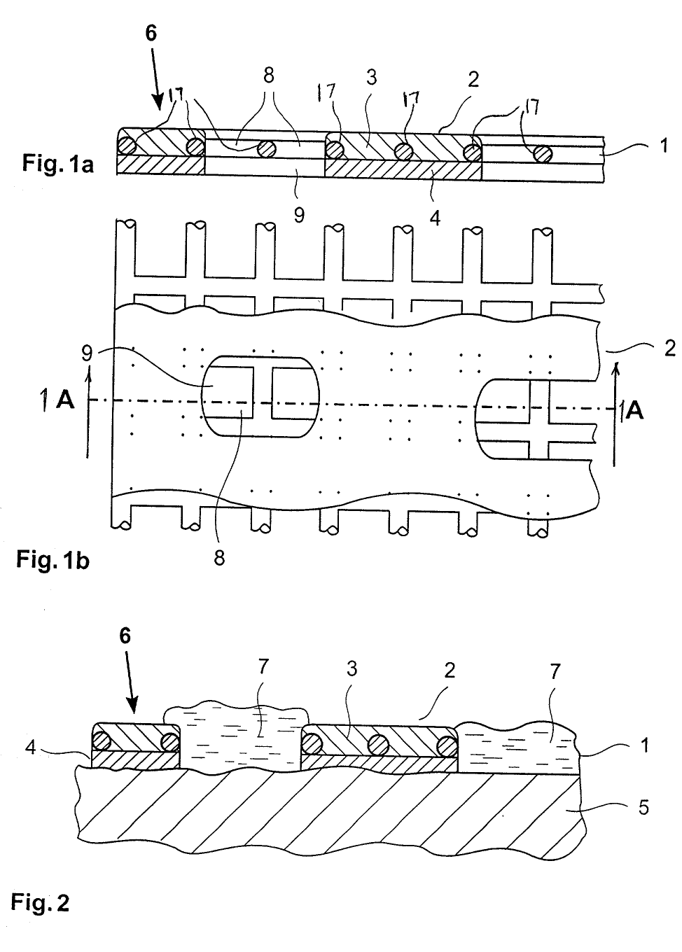

In FIGS. 1A and 1B, a patterning mask 6 is shown. Patterning mask 6 comprises a mesh layer 1 which consists of a set of metallic wires 17 crossing each other at a preferably rectangular angle. Thereby the mesh layer 1 comprises a two-dimensional regular pattern of openings 8 separated by solid elements. This mesh layer 1 provides for a higher rigidity in its mesh plane than in the direction normal to it. A patterned printing layer 2 is arranged partially surrounding the mesh layer 1. The printing layer 2 is made up of two parts, a stencil layer 3 and a seal layer 4. Both parts 3, 4 are patterned, showing the same pattern. The stencil layer 3 consists of a nonelastic material like a standard photoresist material used in lithography. The patterning of the stencil layer 3 is achieved via a standard lithography process, i.e. pouring a liquid photoresist material onto the mesh layer 1, thereby forming a photoresist layer burying the mesh layer 1, illuminating the photoresist layer through a patterned light mask to form soft and hardened areas in the photoresist layer, removing the soft areas thereafter, whereby the hardened areas stay to form stencil layer 3 of the printing layer 2, having orifices in which the mesh layer 1 appears.

Seal layer 4 of printing layer 2 has exactly the same pattern as the stencil layer 3 but is in contrast thereto substantially elastic. It can be manufactured by using a photolithographic step by first providing a layer of elastic material and then patterning it via a lithographic process using a light mask. This process can be the same process as described for forming the stencil layer 3. In fact, stencil layer 3 and seal layer 4 can be patterned in a single step in that the selective illumination reaches both layers 3, 4 at the same time. Therefore, stencil layer 3 and seal layer 4 provide a sufficient transparency that allows the light to effect the selective hardening of both layers 3, 4. Hence, mesh layer 1 together with stencil layer 3 and seal layer 4, can be provided unstructured, and structured to bear the pattern, in a single lithographic step.

As a material for the seal layer 4, UV-curable PDMS or acrylates, hydrophilic polymers, etc. can be used. Seal layer 4 is attached to stencil layer 3 and together with it forms printing layer 2 which is mechanically fixed at mesh layer 1. This combination of mesh layer 1 and printing layer 2 allows to have any desired pattern in printing layer 2, even freestanding objects, like a freestanding disk as being produced when printing the letter “o”.

The elastic layer which is the seal layer 4 of printing layer 2 can also be manufactured and patterned first, then the mesh layer 1 is laid upon the patterned seal layer 4 and afterwards the stencil layer 3 is manufactured photolithographically.

Elasticity is defined as the property whereby a solid material changes its shape and size under action of opposing forces, but recovers its original configuration when the forces are removed. Elastic deformation is defined as the reversible alteration of the form or dimensions of a solid body under stress or strain. Elastic force is defined as the force arising from the deformation of a solid body which depends only on the body's instantaneous deformation and not on its previous history, and which is conservative. The modulus of elasticity is defined as the ratio of the increment of some specified form of stress to the increment of some specified form of strain, such as Young's modulus, the bulk modulus, or the shear modulus. Inelastic is defined as not capable of sustaining a deformation without permanent change in size or shape.

Another manufacturing process would be to define the desired pattern lithographically into a resist on a substrate, e.g. a copper substrate, then electroplating the material for the stencil layer 3, e.g. nickel, into the remaining openings in the structured resist layer on the substrate, whereby the stencil layer 3 is formed, applying the material for the seal layer 4 in an unstructured form onto the resist/nickel layer, performing a second lithographic step using the same light mask as has been used for the previous lithographic step, whereby the seal layer material is structured to have the same pattern as the stencil layer 3, and finally removing the substrate and optionally replacing it with the mesh layer 1.

The patterning mask 6 comprising the two-parted printing layer 2 and the mesh layer 1 is useable as a patterning tool for a printing process as depicted in FIG. 2. Therefor the patterning mask 6 is lowered onto the substantially flat surface of a substrate 5. Afterwards a liquid or viscous material, e.g. a processing solution, hereinafter referred to as ink 7, is poured onto the printing layer 2 whereby this ink 7 flows through the openings in the mesh layer 1 and into the orifices of the printing layer 2. Forces like gravity, centrifugality, pressure, e.g. exerted via a doctor's blade, spraying, application of a vacuum, a directed electric or magnetic field, capillarity etc. may be used for forcing the ink 7 into the orifices.

The elastic seal layer 4 of the printing layer 2 thereby smoothes possible unevennesses of the surface of the substrate 5. Such unevenness could lead to pattern errors like blurring, since the ink 7 could at those unevennesses arrive at places on the substrate 5 where the ink 7 is not desired. This is the more problematic the less viscous the ink 7 is, since this ink 7 can easier reach into smaller gaps which could result from the unevennesses. For creating very small features, e.g. in the micrometer scale, not only the orifices in the printing layer 2 are very small but also the ink 7 is more liquid in order to be able to flow into the orifices of the printing layer 2 and fill them. By reducing pattern errors or even avoiding them by virtue of the sealing provided through the elastic seal layer 4, an exact pattern can be produced. Such exactness might be of lesser relevance in the area of printing conventional pictures or texts but it might be crucial in the area of printing structures for electric circuitry like in integrated circuits or in the circuitry and wiring for a TFT display. A patterning error could render the resulting device erroneous in function and make it useless.

As ink 7, diverse materials can be used, for example, color dyes, biological molecules (DNA, mRNA, proteins.), resist, metal plating solution, polymers, gaseous molecules, electrolytes, metal precursors. For mesh layer 1 a material like a metal or a polymer can be used. For the stencil layer 3 a material like a polymer, resist or metal can be used.

The patterned printing layer 2, when in contact with the substrate 5, provides at the interface between the substrate 5 and the printing layer 2 a seal for ink 7 that is fillable into the orifices 9 of the patterned printing layer 2 and reaches the substrate 5. Ink 7 is confined to the area of the respective orifice 9.

Once ink 7 has come into contact with the substrate surface in the area of the orifices 9 of the patterning mask 6 at least part or a portion of the ink 7 stays there. If ink 7 contains a solvent, a predetermined time period can be used until at least part of the solvent has dissolved. Afterwards, patterning mask 6 can be removed from substrate 5 whereby the ink pattern remains. Using an ink 7 that without the sealing through the seal layer 4, ink 7 would flow into areas where it is not desired, which herein is referred to as a thin ink 7. Thin ink 7 has the advantage that sharper edges of patterns can be achieved since ink 7 reaches better into any edge of the patterning mask 2. Furthermore, thinner ink 7 can reach into smaller orifices 9 hence allowing to create a pattern with smaller feature size. Further, there are specific inks 7 that are only available as thin ink 7 and that can not be rendered more viscous. Such inks 7 can be printed with this patterning mask 6.

This printing step can be repeated with different patterns and different materials.

This arrangement is even of advantage when being used on a very flat and even substrate 5 since, first, it typically can not or only with a very costly process be guaranteed that the surface is absolutely even, second, the patterning mask 6 could suffer from some unevenness itself and third, the substantially even surfaces of the patterning mask 6 and of the substrate 5 lead to an adhesion force which forces the patterning mask 6 onto the substrate 5. This adhesion force can be strong enough that no additional force is necessary to press the patterning mask 6 onto the substrate 5 and furthermore it automatically guarantees that the patterning mask 6 rests at its intended position. A lateral position control is hence not necessary. Furthermore, when no force is exerted onto the patterning mask, the risk of geometric distortions of patterning mask 6 is reduced.

Seal layer 4 need not bear the exact same pattern as stencil layer 3. It is in the end seal layer 3 which determines the final pattern that is created on the substrate 5. Hence a certain imprecision is affordable for the stencil layer 3. If the stencil layer 3 has to a certain extent bigger orifices 9 than the orifices 9 in the seal layer 4 this may increase the precision of the final pattern because the adhesion force present between the elastic material of seal layer 4 and substrate 5 can have a stronger effect at the areas where the seal layer 4 is freestanding. The mesh layer 1 has a mesh size that to some extent determines the resolution of the patterning mask 6. The finer the mesh layer 1, the denser is the web of wires where the printing layer 2 finds mechanical support. Whereas non-freestanding objects find additional mechanical support at their own printing layer 2 and hence need not mandatorily have at their edges a part of the mesh layer 1 as support, freestanding objects definitely need a binding to the mesh layer 1 to be correctly positioned and held. In any case the mesh layer 1 being dimensioned in its mesh size such that at any edge of the stencil pattern a part of the mesh layer 1 is present provides the best precision for the resulting pattern.

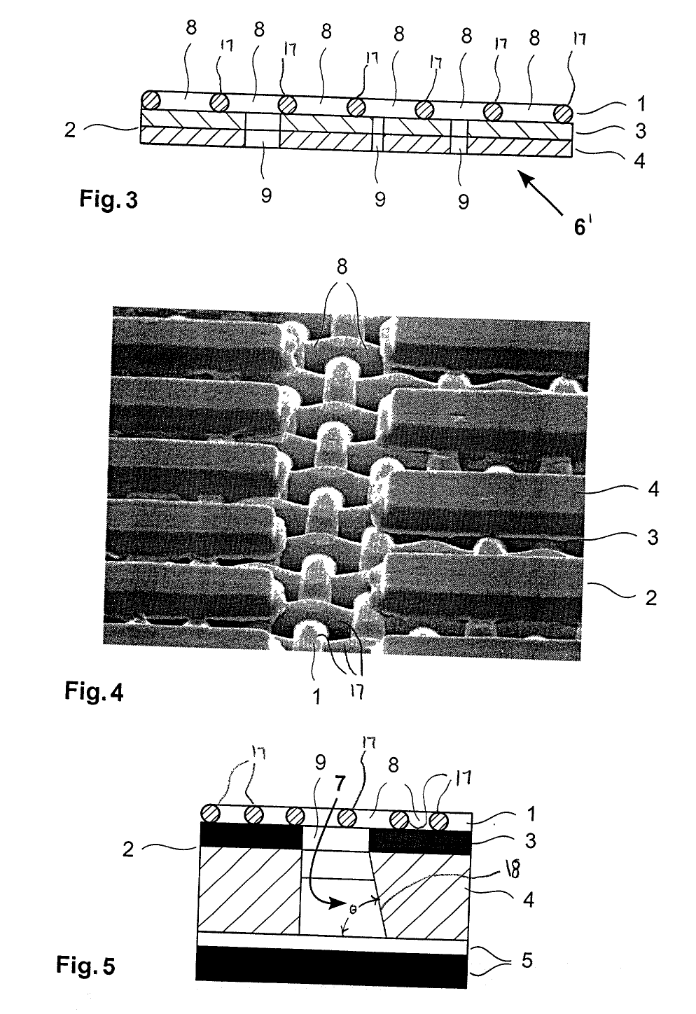

In FIG. 3, a second embodiment of the patterning mask 6′ is shown. It differs from the embodiment in FIGS. 1A and 1B in that printing layer 2 is not surrounding mesh layer 1 partially, but is only attached to wires 17 of mesh layer 1 at its underside. This attachment can be achieved via an additional glue layer or via a gluing functionality of the stencil layer 3. In this embodiment, stencil layer 3 can be thinner than the mesh layer 1. Furthermore, here orifices 9 are smaller than openings 8 of the mesh layer 1. Since stencil layer 3 provides for mechanical stability in the vertical direction, the seal layer 4 is sufficiently supported to be able to provide its sealing functionality even in the area where it is not directly supported by mesh layer 1. This means that the mesh size is not determining the achievable pattern dimensions.

In FIG. 4, a photograph of a patterning mask 6′ according to FIG. 3 is shown. The mesh layer 1 comprises a woven wire mesh and the printing layer 2 here has a pattern in form of several parallel stripes. It can be clearly seen that the printing layer 2 lies on top of the mesh layer 1 and does not extend into the openings 8. Furthermore one can see that the printing layer 2 has edges at positions where no wire 17 of the mesh layer 1 is located. Nevertheless, the printing layer is planar and even. The unevenness of the mesh layer 1 does not influence the evenness of the printing layer 2.

The seal layer 4 need not have vertical walls in the orifices 9. It can also have inclined walls at an angle theta less than 90 degrees which allows for the ink 7 to produce patterns which have inclined walls as well. An example therefor is depicted in FIG. 5. Such a tilted structure can be formed by molding or photolithography of the seal layer 4.

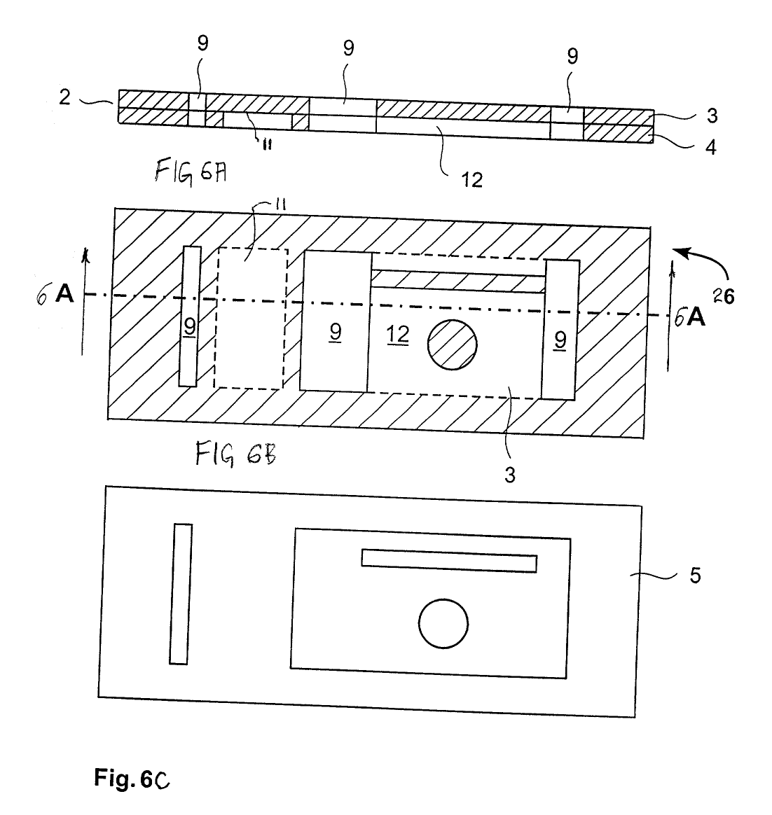

In FIG. 6A, a cross section view of patterning mask 26 with a subpatterned seal layer 4 is shown. For sake of clarity, mesh layer 1 is here not depicted. Seal layer 4 has a different pattern than stencil layer 3. FIG. 6B shows a top view of the patterning mask 26, whereby the seal layer 4 underneath the stencil layer 3 is outlined by dashed lines and filled with hatched lines. FIG. 6A shows a cut through the patterning mask 6 along line A-A of FIG. 6B. Seal layer 4 has a covered area 11 which is totally covered by the stencil layer 3, such that no ink 7 can get into that covered area 11. Seal layer 4 has a reachable area 12 which is covered by the stencil layer 3 but which is reachable by ink 7 through the orifices 9. Ink 7 when being poured into the orifices 9, flows into reachable area 12 and can cover substrate 5 there. The resulting pattern is depicted in FIG. 6C.

Seal layer 4 can be absent in those regions such as area 11 where the stencil layer 4 serves as a cover, whereby the area where stencil layer 4 is absent is not contacted by the patterning mask 26. This can be of advantage when this area is sensitive to contact and a contact is desired to be avoided. Several of the patterning masks 26 can be stacked whereby different patterns can be created. For instance, a first ink 7 can be brought onto the substrate 5 using a first patterning mask 6, then a second patterning mask 26 can be applied onto the first patterning mask 26 whereby a reduced set of orifices 9 is the consequence such that a second ink 7 can be applied onto a part of the ink pattern created with the first patterning mask 26.

Any disclosed embodiment may be combined with one or several of the other embodiments shown and/or described. This is also possible for one or more features of the embodiments.

While there has been described and illustrated a patterning mask containing a stencil layer and a sealing layer, it will be apparent to those skilled in the art that modifications and variations are possible without deviating from the broad scope of the invention which shall be limited solely by the scope of the claims appended hereto.

Having thus described our invention, what we claim as new and desire to secure by Letters Patent is:

1. A patterning mask comprising:
a substantially planar patterned printing layer comprising a substantially inelastic stencil layer that comprises a pattern of orifices separated by solid elements, said printing layer providing a rigidity in its plane, and
a substantially elastic seal layer that is fixed at said stencil layer and that when being in contact with a substrate, serves as a seal for a liquid or viscous material that is fillable through the patterned printing layer onto said substrate.

2. The patterning mask according to claim 1, further comprising a mesh layer comprising a two-dimensional regular pattern of openings separated by solid elements, said mesh layer being arranged at the stencil layer on the opposite side of the seal layer.

3. The patterning mask according to claim 2, characterized in that the stencil layer extends into some of the openings of the mesh layer.

4. The patterning mask according to claim 2, characterized in that the mesh layer is partially buried in the stencil layer.

5. The patterning mask according to claim 2, characterized in that the mesh layer comprises a web of wires or overplated wires.

6. The patterning mask according to claim 1, characterized in that the stencil layer comprises a photoresist material, metal, glass or silicon.

7. The patterning mask according to claim 1, characterized in that the seal layer and the stencil layer comprise a substantially similar pattern.

8. The patterning mask according to claim 1, characterized in that the seal layer covers at least part of the area of the stencil layer.

9. The patterning mask according to claim 1, characterized in that the substantially elastic material comprises an optically curable elastomer, preferably a prepolymer, monomer or a mixture thereof that reacts upon an irradiation with UV or visible light to form an elastomer network.

10. The patterning mask according to claim 1, characterized in that the orifices have a minimum extension that is smaller than the minimum extension of the openings.

11. The patterning mask according to claim 1, characterized in that the printing layer is thinner than the mesh layer.

12. A patterning method for creating a pattern on a substrate comprising the steps of:
laying onto said substrate a patterning mask comprising a substantially planar, patterned printing layer which comprises a substantially inelastic stencil layer and a substantially elastic seal layer that is fixed at said stencil layer,
bringing a liquid or viscous or gaseous material onto said patterning mask, whereby said patterned printing layer serves at the interface between said substrate and said patterning mask as a seal for said liquid or viscous or gaseous material that flows through said patterned printing layer onto said substrate, and
removing said patterning mask from said substrate, leaving said pattern behind.

13. The patterning method according to claim 12, wherein said step of bringing a liquid or viscous material includes the step of applying a force to force said liquid or viscous material towards said substrate.
